(19) United States
(12) Patent Application Publication
(10) Pub. No.: US 2011/0046896 A1
(43) Pub. Date: Feb. 24, 2011

(54) ALCOHOL THERMAL DEHYDRATATION CHAMBER, APPARATUS AND METHOD FOR DETERMINATION OF ISOTOPIC COMPOSITION OF NON-EXCHANGEABLE HYDROGEN AND DEUTERIUM ATOMS IN ETHANOL SAMPLES

(76) Inventor: Ivan Smajlovic, Becej (RS)

Correspondence Address: TODOR OZEGOVIC, 14516 West 50th Street, Shawnee, KS, 66216, US

(21) Appl. No.: 12/989,414

(22) PCT Filed: Jun. 19, 2008
(86) PCT No.: PCT/RS2008/000022

§ 371 Date: Oct. 23, 2010

(30) Foreign Application Priority Data
May 15, 2008 (RS) P-2008/0208

(51) Int. Cl. H01J 49/26; G06F 19/00

(52) U.S. Cl. 702/24; 250/282

(57) ABSTRACT

The invention is related to the instrumental analytical chemistry, further more to the stable isotope determination in food products. The present invention is referred to the alcohol thermal dehydration chamber, apparatus for “online” determination of isotopic composition of non-exchangeable hydrogen stable isotopes in ethanol samples, which comprises of: A) Alcohol thermal dehydration chamber, B) Detection device, which contains pyrolysis reactor and the Continuous Flow Isotope Spectrometer, and it is connected to the alcohol thermal dehydration chamber over C) System of valves, connectors and capillary tubes which are used for transfer of analyzed sample as for the purging of the alcohol thermal dehydration chamber; procedure for “online” determination of isotopic composition of non-exchangeable hydrogen stable isotopes in ethanol samples and procedure for “offline” preparation of ethene (ethylene) gas by means of alcohol thermal dehydration chamber and for the purpose of authenticity and geographical origin determination of wines, strong spirits, beer, fruit juices, honey and other food product which contain alcohol and/or fermentable sugars.

### TECHNICAL FIELD

The present invention is related to the alcohol thermal dehydration chamber, apparatus and method for “online” determination of isotopic composition of non-exchangeable hydrogen stable isotopes in ethanol samples and method for “offline” preparation of ethene (ethylene) samples by means of the alcohol thermal chamber for the purpose of authenticity and geographical origin determination of wines and grape musts, beer, strong spirits, fruit juices, honeys and all other food products which contains alcohol (ethanol) and/or fermentable sugars.

### BACKGROUND ART

Isotopic methods have shown that they can be very powerful analytical tool for authenticity and geographical origin determination of wines and strong spirits. By measuring the content of stable isotopes in these products useful information can be provided for detection of many frauds in production of wine and must, strong spirits, fruit juices honey and other food products which contain alcohol and/or fermentable sugars. Instrumental techniques which are used for isotopic measurements are based on measuring the relative ratios of stable isotopes by means of Isotope Ratio Mass Spectrometry.

Systems comprising a pyrolysis chamber and continuous flow isotope spectrometer CF—TC/EA—IRMS (for example Flash HT Continuous Flow—Temperature Conversion/Elemental Analyzer—Isotope Ratio Mass Spectrometry from Thermo Electron Corporation) are commercially available for stable hydrogen analysis of solid and liquid samples.

When analyzing ethanol samples, by means of CF—TC/EA—IRMS (Continuous Flow—Thermal Conversion/Elemental Analyzer—Isotope Ratio Mass Spectrometry), because of the ethanol's hydroxyl group, which contains easily exchangeable hydrogen, gained δD values for ethanol of the same botanical and geographical origin can vary, and for that reason it is impossible to perform qualitative and quantitative identification of the ethanol sample origin.

One of the problems which can occur, for example, in strong spirit production, is in finalization production steps. The distillate is diluted with water to determined alcoholic strength which is necessary so that alcoholic drink could be consumed. By adding water which has different isotopic content, dynamic isotopic equilibrium is disturbed and hydrogen or deuterium which is bonded to oxygen atom of the hydroxyl group is exchanged. This is one of the reasons for gaining the wrong δD values and wrong information about ethanol origin.

Because of the problems which are stated above, instrumental technique CF—TC/EA—IRMS can not be very useful in detection of frauds in wine and alcoholic drinks production and moreover for detection of ethanol which originates from beet sugar, barley, wheat etc. in wine and alcoholic drinks.

According to the first aspect of this invention, the alcohol thermal dehydration chamber, apparatus and method for “online” determination of isotopic composition of non-exchangeable stable isotopes in ethanol samples and also the method for the “offline” preparation of ethene (ethylene) samples by means of the alcohol thermal dehydration chamber, give the possibility to dehydrate ethanol and to remove exchangeable hydrogen (or deuterium) atom of the hydroxyl group without any lost or isotopic fractionation. In that way stabilization and constant SD values are achieved and this comes from other atoms of hydrogen and deuterium which are strongly bonded to carbon atoms inside of ethene (ethylene) gas which is prepared from ethanol sample with particular botanical origin.

### DISCLOSURE OF THE INVENTION

Deuterium and hydrogen relative ratio measurements for the proposal of authenticity and origin determination of wines and alcoholic drinks, beer, fruit juices and honey today is done by means of NMR methodology (Site Natural Isotopic Fractionation—Nuclear Magnetic Resonance) which is based on intermolecular scanning of the measured ethanol sample and determination of isotopic composition of hydrogen and deuterium atoms sited on the first and on the second carbon atom inside of the ethanol molecule. Results gained by NMR methodology give the information about the presence of ethanol which originates from beet sugar or other industrial plants, and which belongs to the C3 plant group.

This instrumental technique is very precise, but it has some lacks. Some of those lacks are:
In the first place SNIF-NMR is very expansive instrument and method and it requires big financial funds (big consumption of helium and liquid nitrogen and also electrical energy),
Time needed for analysis is quite long (small number of samples can be analyzed),
It occupies big part of the working place because of it's size and because of the very strong magnetic field which it makes (security zone is needed),
Standards which are used in analysis are expensive.

### DISCLOSURE OF THE INVENTION

The main goal of this invention is to overcome the barrier and lacks of today known apparatus and methods for determination of isotopic composition of non-exchangeable hydrogen and deuterium atoms in ethanol samples.

The foregoing and further objects are achieved by the alcohol thermal dehydration chamber of claim 1, apparatus for “online” determination of isotopic composition of non-exchangeable hydrogen stable isotopes in ethanol samples of claim 2, the alcohol thermal dehydration chamber according to claim 1 and variant 1 for “offline” preparation of ethene (ethylene) samples of claim 3, procedure for “online” determination of isotopic composition of non-exchangeable hydrogen stable isotopes in ethanol samples of claim 4 and procedure for “offline” preparation of ethene (ethylene) samples using the alcohol thermal dehydration chamber of claim 5.

According to the first aspect of this invention the alcohol thermal dehydration chamber comprises of: the reaction vessel which contains upper opening with the stopper and septa, which is used for the ethanol sample injection by syringe, and sideway left opening with the valve which purpose is purging of the chamber with the inert gas helium. One part of the reaction vessel poses thermo-jacket which comprises of two electrical heaters. Also as the alternative for thermo-jacket the open flame can be used for the reaction vessel heating. The second part of the reaction vessel, this part has a tube shape turned to the right side, contains dehydration catalyst and for that purpose aluminum oxide (Al₂O₃), silica gel, zeolite or the mixture of those substances or similar materials can be used. At the right end the reaction vessel is connected with tube with the gas tight stopper. Inside of this tube with a gas tight stopper small amount of silica gel or similar inert hygroscopic material can be placed. The right end of this tube with gas tight stopper contains two valves, which are used for purging of the alcohol thermal dehydration chamber with the helium gas. The alcohol thermal dehydration chamber lies on the stand.

The alcohol thermal dehydration chamber can be applied as the part of the apparatus for online determination of isotopic composition of non-exchangeable hydrogen and deuterium atoms in ethanol samples and as a variant solution for the offline preparation of ethene (ethylene) samples. If it is used as a variant solution for the offline preparation of ethene (ethylene) samples, the alcohol thermal dehydration chamber is connected to the previously vacuumed vial which has the role for taking the ethene gas. Prepared ethene gas is then injected with the gas tight syringe on to existing state of instrumental technique CF—TC/EA—IRMS or GC/TC—IRMS (Gas Chromatography/Thermal Conversion—Isotope Ratio Mass Spectrometer).

According to a further aspect of this invention the apparatus for online determination of isotopic composition of non-exchangeable hydrogen stable isotopes in ethanol samples comprises of: A) alcohol thermal dehydration chamber, B) detection device, which contains pyrolysis reactor and the continuous flow isotope spectrometer, and it is connected to the alcohol thermal dehydration chamber over C) system of valves, connectors and capillary tubes which are used for transfer of analyzed sample as for the purging of the alcohol thermal dehydration chamber.

It will be understood that the apparatus will generally comprise additional features known in the art e.g. control and processor units interacting with the functional components of the apparatus (automatic manipulating). It may be contemplated to adopt or appropriately modify available laboratory equipment to control and interact with the apparatus of this invention.

According to a further aspect of this invention the procedure and principle for “online” determination of isotopic composition of non-exchangeable hydrogen stable isotopes in ethanol samples is conceived on preliminary purging of the alcohol thermal dehydration chamber in stream of inert gas helium, injection of the ethanol sample into the reaction vessel (injection can be done manually or by means of auto-sampler), alcohol heating and production of overheated alcoholic fumes, and crossing of those ethanol fumes over dehydration catalyst (aluminum oxide—Al₂O₃, silica gel, zeolite or the mixture of those substances or similar materials) which results in immediate alcohol dehydration and removal of water. Incurred ethene (ethylene) gas is carried in the stream of the gas helium to the pyrolysis reactor. Elemental gases produced by pyrolysis of prepared ethene (H₂ and CO) go through the gas chromatography column where are separated, and over interface and the Open Split enter IRMS where are detected.

According to a further aspect of this invention procedure and principle for “offline” preparation of ethene samples with the use of the alcohol thermal dehydration chamber is conceived on preliminary purging of the alcohol thermal dehydration chamber in stream of the inert gas helium through the left sideway by opening the valve for the helium gas. Before purging is done it is needed to open valves on the right side of the chamber. After purging is done it is needed to close right sided valves and then the valve for helium gas. After purging on the metal needle, at the right end, connect the previously vacuumed vial, and open the valve on the right side of the chamber. Further, by heating the reaction vessel by means of thermo-jacket or alternatively by open flame, and injecting the ethanol sample previously isolated from wine, strong spirit, beer etc. to the reaction vessel, dehydration reaction takes place and formed gas ethene is captured inside the vial. After this vial is taken off from the chamber and ethene is then manually injected with the gas tight syringe on to existing state of instrumental techniques CF—TC/EA—IRMS or GC/TC—IRMS.

### BRIEF DESCRIPTION OF DRAWINGS

The above mentioned and other features and objects of this invention and the manner of achieving them will become more apparent and this invention itself will be better understood by reference to the following description of various embodiments of this invention taken in conjunction with the accompanying drawings, wherein:

FIG. 1—Shows of the alcohol thermal dehydration chamber;

FIG. 2—Shows review of the apparatus for “online” determination of isotopic composition of non-exchangeable hydrogen stable isotopes in ethanol samples;

FIG. 3—Shows review of variance 1 the alcohol thermal dehydration chamber of “offline” preparation of ethene samples and for the existing state of instrumental techniques CF—TC/EA—IRMS or GC/TC—IRMS

### BEST MODES FOR CARRYING OUT OF THE INVENTION

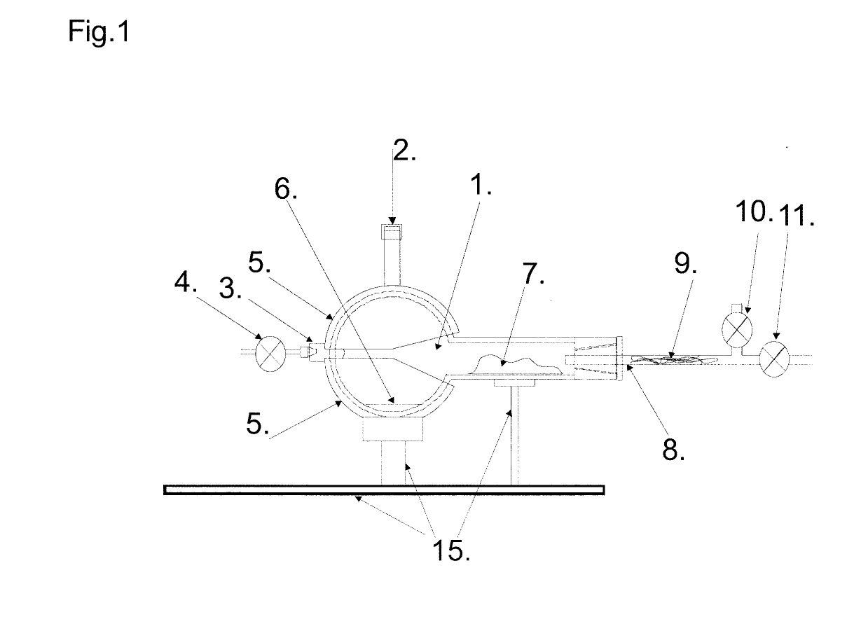

In accordance with the idea of the invention FIGS. 1, 2 and 3 are showing pictures of the alcohol thermal dehydration chamber, apparatus for “online’ determination of isotopic composition of non-exchangeable hydrogen stable isotopes in ethanol samples and variant solution of the alcohol thermal dehydration chamber for the “offline” preparation for ethene (ethylene) samples for the existing state of instrumental techniques CF—TC/EA—IRMS.

According to the idea for the present invention FIG. 1 shows the alcohol thermal dehydration chamber. FIG. 1 shows all important parts of the alcohol thermal dehydration chamber. The alcohol dehydration chamber comprises of: the reaction vessel (1) which contains upper opening with the stopper and septa (2), which is used for injection of ethanol sample (6) by syringe, and sideway left opening (3) with valve for gas helium (4) which purpose is purging of the chamber with the inert gas helium. One part of the reaction vessel poses thermo-jacket (5) which comprises of two electrical heaters. Also as the alternative to thermo-jacket (5) the open flame can be used for the reaction vessel heating. The second part of the reaction vessel, this part has a tube shape turned to the right side at FIG. 1, contains dehydration catalyst (7) and for that purpose aluminum oxide (Al₂O₃), silica gel, zeolite or mixture of those substances or similar materials can be used. At the right end the reaction vessel is connected with tube with the gas tight stopper (8). Inside of this tube with the gas tight stopper (8) small amount of quartz wool, silica gel of similar inert hygroscopic material can be placed (9). The right end of this tube with the gas tight stopper (8) contains two valves (10) and (11), which are used for purging of the alcohol thermal dehydration chamber with inert gas helium. The alcohol thermal dehydration chamber lies on the stand (15).

In accordance with the idea of this invention the alcohol thermal dehydration chamber gives the possibility to dehydrate ethanol and to remove exchangeable hydrogen (of deuterium) atom of the alcohol hydroxyl group without any lost of isotopic fractionation. In that way stabilization and constant δD values are achieved and this comes from other hydrogen and deuterium atoms which are strongly bonded to carbon atoms inside of ethene (ethylene) gas which is prepared from ethanol samples with particular botanical origin.

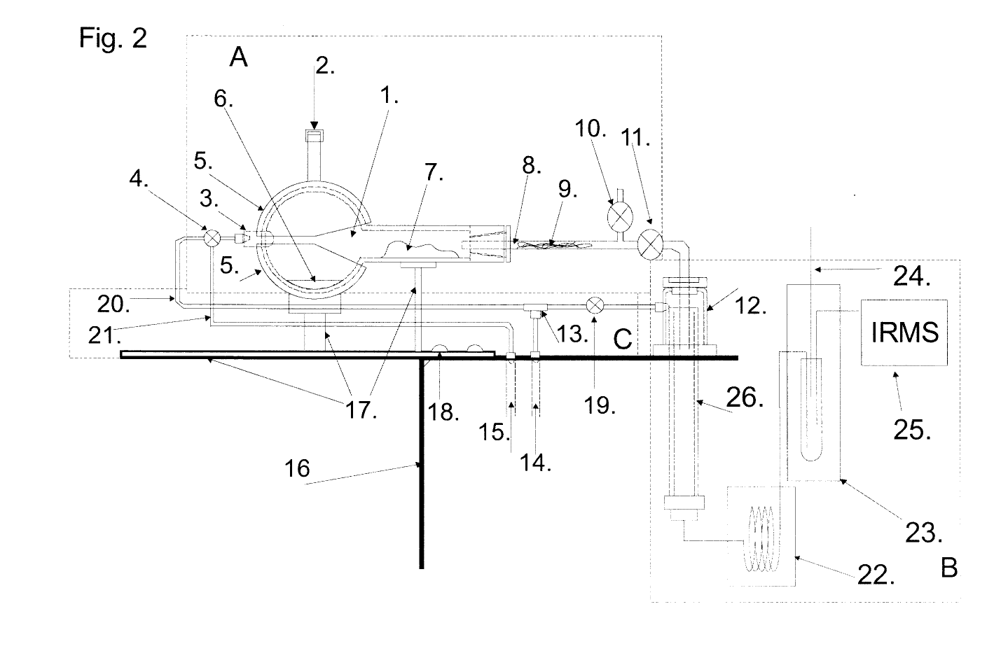

In accordance with the idea of this invention FIG. 2 shows in detail the apparatus for the “online” determination of isotopic composition of non-exchangeable hydrogen stable isotopes in ethanol samples. FIG. 2 shows all important parts of the apparatus for the online determination of isotopic composition of non-exchangeable hydrogen stable isotopes in ethanol samples from which it is comprised.

In accordance with the idea of this invention the apparatus for “online” determination of isotopic composition of non-exchangeable hydrogen stable isotopes in ethanol samples comprises of: A) alcohol thermal dehydration chamber, B) detection device, which contains pyrolysis reactor and the continuous flow isotope spectrometer, and it is connected to the alcohol thermal dehydration chamber over C) system of valves, connectors and capillary tubes which are used for transfer of analyzed sample as for the purging of the alcohol thermal dehydration chamber in stream of helium gas. The alcohol thermal dehydration chamber, which is the part of the apparatus for “online’ determination of isotopic composition of non-exchangeable hydrogen stable isotopes in ethanol samples, comprises of: the reaction vessel (1) which contains upper opening with stopper and septa (2), which is used for injection of ethanol sample (6) by syringe, and left sideway opening (3) with the “Switch” valve for the “Reference” and “Carrier” gas helium (4). One part of the reaction vessel poses thermo-jacket (5) which comprises of two electrical heaters. The second part of the reaction vessel, this part has a tube shape turned to the right side at FIG. 1, contains dehydration catalyst (7) and for that purpose aluminum oxide (Al₂O₃), silica gel, zeolite or the mixture of those substances or similar materials can be used. At the right end the reaction vessel is connected with tube with the gas tight stopper (8). Inside of this tube, with the gas tight stopper (8), small amount of quartz wool or silica gel (9). The right end of this tube with the gas tight stopper (8) contains two valves (10) and (11). Tube with the gas tight stopper (8) at its end is connected via injection connector (12) directly to the pyrolysis reactor (26), which is connected via gas chromatography column (22) and Interface Open Split (23), which has the capillary for Helium dilution (24), with the Isotope Ratio Mass Spectrometer IRMS (25). The alcohol thermal dehydration chamber lies on the stand (17) which is fixed to the housing of the peripheral (16), which contains pyrolysis reactor (26), with screws (18). Capillary tube (21) at one end is connected with the output of the helium “Reference” gas (15), which is used for chamber purging, and at it's other end connected with the “Switch” valve (4). The capillary tube (20) is, over “T” connector (13), at one end, connected with the main flow output of the helium “Carrier” gas (14), and at it's other end connected with the “Switch” valve (4). The main flow output of the helium “Carrier” gas (14) is connected via “T” connector (13) and the capillary tubing with the security valve (19) and injection connector (12) on the pyrolysis reactor (26).

In accordance with the idea of this invention the procedure and principle for working with the apparatus for “online” determination of isotopic composition of non-exchangeable hydrogen stable isotopes ethanol samples follows as is:

The first phase is related to purging of the alcohol thermal dehydration chamber, which is the part of the apparatus for “online’ determination of isotopic composition of non-exchangeable hydrogen stable isotopes in ethanol samples, with the inert gas helium. Before purging begins it is necessary to close the valve (11) and to open the valve (10), and then, over sideway opening (3) and by moving the “Switch” valve (4) to the position for the “Reference” gas helium (21) start to purge the alcohol thermal dehydration chamber. The flow of the “Reference” gas helium should be in the range from 20 ml/min. to 200 ml/min. After purging is done, this should last maximum 15 minutes, close the valve (10), and then open the valve (11) and move the “Switch” valve (4) in the position for the main flow of the “Carrier” gas helium (20). The flow of the “Carrier” gas helium should be in the range from 70 ml/min. to 170 ml/min. After purging of the alcohol thermal dehydration chamber is done, heating of the reaction vessel (1) by means of the thermo-jacket (5) may start until the temperature reaches the range from 250° C. to 500° C. After this is done inject maximum 1 ml, of preliminary distillated and isolated alcohol (ethanol) sample from analyzed wine, beer or alcoholic drink or similar. By entering the reaction vessel, sample is momentarily vaporized into overheated alcoholic fume which, in the stream of helium, passes over dehydration catalyst (7). With dehydration and separation of water and absorption by the catalyst in the surplus, prepared ethene (ethylene) gas, through the capillary tube with the gas tight stopper (8) and opened valve (11), is entering the pyrolysis reactor (26) and then, over gas chromatography column (22) and Interface with the Open Split (23) is detected on the Isotope Ratio Mass Spectrometer IRMS (25). Formed gas ethene (ethylene) prepared by means of the alcohol thermal dehydration is degraded by pyrolysis to the elemental gases (H₂ and CO) which then pass through the gas chromatography column where are separated, and then over Interface and its Open Split are entering the IRMS where are finally detected.

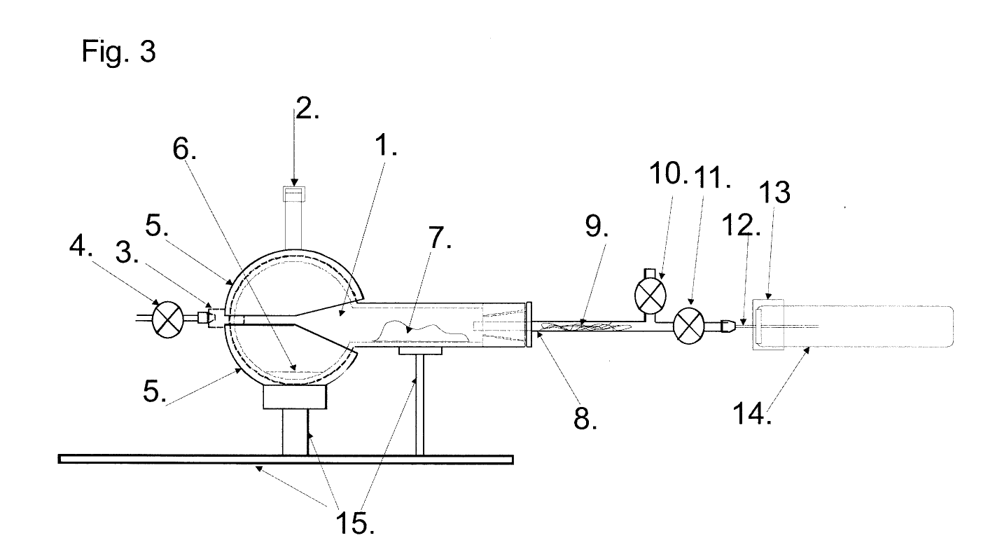

In accordance with the idea of this invention FIG. 3 shows that variant solution for the alcohol thermal dehydration chamber for the “offline” preparation of ethene (ethylene) samples for the existing state of instrumental techniques CF—TC/EA—IRMS or GC/TC—IRMS. FIG. 3 shows all important parts of the variant solution for the alcohol thermal dehydration chamber for “offline’ preparation of ethene (ethylene) samples for the existing state of instrumental techniques CF—TC/EA—IRMS or GC/TC—IRMS. The variant solution for the alcohol thermal dehydration chamber comprises of: reaction vessel (1) which contains upper opening with the stopper and septa (2), which is used for injection of ethanol sample (6) by syringe and sideway left opening (3) with valve (4) which purpose is purging of the chamber with the inert gas helium. One part of the reaction vessel poses thermo-jacket (5) which comprises of two electrical heaters. Also as the alternative for the thermo-jacket (5) the open flame can be used for the reaction vessel heating. The second part of the reaction vessel, this part has a tube shape turned to the right side at FIG. 3, contains dehydration catalyst (7) and for that purpose aluminum oxide (Al₂O₃), silica gel, zeolite or the mixture of those substances or similar materials can be used. At the right end the reaction vessel is connected with tube with the gas tight stopper (8). Inside of this tube with gas tight stopper (8) small amount of quartz wool, silica gel or similar inert hygroscopic material can be placed (9). The right end of this tube with the gas tight stopper (8) contains two valves (10) and (11), which are used for purging of the alcohol thermal dehydration chamber with inert gas helium. At the right end, the tube with the gas tight stopper (8) is connected with metal needle (12) and via stopper (13) with the vial (14). The alcohol thermal dehydration chamber lies on the stand (15).

In accordance with the idea of this invention the procedure for the “offline” preparation of ethene (ethylene) samples by means of the alcohol thermal dehydration chamber follows as is:

The first phase is related with purging of the alcohol thermal dehydration chamber with the inert gas helium over sideway opening (3) by opening the valve for helium gas (4). Before releasing the helium stream it is needed to open the valves (10) and (11). After purging of the dehydration chamber the valves (10) and (11) have to be closed and then the valve for the helium gas (4) is closed too. After this is done, preliminary vacuumed vial (14) is put on the metal needle (13) and the valve (11) is opened. After purging of the alcohol thermal dehydration chamber is done, heating of the reaction vessel (1) by means of thermo-jacket (5) may start until the temperature reaches the range from 250° C. to 500° C. Alternatively for heating of the reaction vessel open flame can be used. After this is done preliminary distilled and isolated alcohols (ethanol) sample from analyzed wine, beer or alcoholic drink or similar is injected and after reaction time of up to 5 minutes the valve (11) is closed and the vial (14) is disconnected from the dehydration chamber. Prepared gas ethene (ethylene) caught inside the vial (14) is used for manual injection by means of the gas tight injection syringe to the instrumental system CF—TC/EA—IRMS or GC/TC—IRMS.

In accordance with the idea of this invention, the apparatus for thermal alcohol dehydration and the procedure for determination of relative isotopic composition of all non-exchangeable hydrogen and deuterium atoms in ethanol samples, and for the purpose of authenticity and geographical origin determination of wines and grape musts, beers, alcoholic drinks, fruit juices, honey and all other food products which contain alcohol and/or fermentable sugars, it has it's advantages:
In the first place, it gives very good precision and repeatability of results for δD values of analyzed ethanol samples, no matter if ethanol sample was diluted with water before distillation, and it gives espied constant difference and dependence between ethanol samples with botanical origin from C3 group of plants;
Time of the analysis is quit shorter in compare to the NMR methodology;
There is no need for big financial funds and special conditions for maintenance like which is the case with instrumental technique NMR methodology,
No safety zone is needed and does not require big working space (it can be installed on existing instrumental technique CF—TC/EA—IRMS),
It uses existing certified referent materials and standards which are already in use in isotopic mass spectrometry;
It gives the opportunity to detect the presence of ethanol which originates from beet sugar, wheat, barley and other industrial plants which belong to the C3 group of plants, in the ethanol samples which are isolated from the analyzed wines and alcoholic drinks.
   It will be appreciated that modifications to the embodiments described above are of course possible. Accordingly the present innovation is not limited to the embodiments described above.

### INDUSTRIAL APPLICABILITY

The alcohol thermal dehydration chamber, apparatus and procedure for “online” determination of isotopic composition of non-exchangeable hydrogen stable isotopes in ethanol samples and the procedure for “offline” preparation of ethene (ethylene) samples by means of alcohol thermal dehydration chamber are applicable in instrumental analytical chemistry and are used for authenticity and geographical origin determination of wines and grape musts, alcoholic drinks, beers, fruit juices, honey and other food products which contain ethanol and/or fermentable sugars.

1-7. (canceled)

8. An apparatus for determining origin of an alcohol-containing food product, comprising:
an alcohol dehydration chamber for receiving an alcohol sample from the alcohol-containing food product and converting most of the alcohol sample into an ethene gas;
a pyrolysis reactor for degrading the ethene gas into a gaseous mixture comprising hydrogen and carbon-monoxide gases;
a gas chromatography column for separating a hydrogen gas from the gaseous mixture;
an open-split capillary interface; and
an isotope ratio mass spectrometer for measuring an isotopic composition, i.e., isotopic relative ratio of hydrogen and deuterium in the hydrogen gas, and for calculating a deltaD value for the measured isotopic composition.

9. The apparatus of claim 8, wherein the alcohol dehydration chamber comprises:
a reaction vessel having an opening with stopper and septa for injecting the alcohol sample,
an intake switch-valve having at least two settings, a first setting for introducing a reference helium gas and a second setting for introducing a carrier helium gas into the dehydration chamber,
a thermo-jacket for heating the reaction vessel,
a dehydration catalyst,
a hygroscopic material for removing water vapor,
a purging valve for purging the dehydration chamber by releasing the introduced reference gas along with gases generated from prior use of the dehydration chamber, and
a sampling valve for conducting the carrier gas mixed with the ethene gas to the pyrolysis reactor.

10. The apparatus of claim 8, further comprising an injection connector in fluid communication with the alcohol dehydration chamber and the pyrolysis reactor.

11. The apparatus of claim 8, wherein the open-split capillary interface further comprises a capillary for dilution.

12. The apparatus of claim 9, further comprising a T-connector in fluid communication with a source of the carrier helium gas, the intake switch-valve, and a security valve connected to the pyrolysis reactor.

13. A process for determining origin of an alcohol-containing food product, comprising:
extracting an alcohol sample from the alcohol-containing food product;
at least partly converting by dehydration the alcohol sample into an ethene gas;
at least partly degrading by pyrolysis the ethene gas into a gaseous mixture comprising a hydrogen gas and a carbon-monoxide gas;
separating the hydrogen gas from the gaseous mixture;
measuring an isotopic composition, i.e., isotopic relative ratio of hydrogen and deuterium in the hydrogen gas;
calculating a deltaD value for the measured isotopic composition; and
comparing the calculated deltaD value with deltaD values of food products having known origins.

14. The process of claim 13, wherein the alcohol-containing food product is selected from the following group comprising: wine, alcoholic beverages, fermented fruit juices, diluted and fermented honey, food products containing ethanol, food products containing fermentable sugars, and any combination thereof.

15. The process of claim 13, wherein converting by dehydration comprises using a dehydration catalyst.

16. The process of claim 15, wherein the dehydration catalyst is selected from the following group comprising: Al2O3, silica gel, zeolite, and any combination thereof.

17. A process for determining origin of an alcohol sample, comprising:
converting alcohol molecules from the alcohol sample into alkene molecules by removing unstable hydroxyl groups from the alcohol molecules;
discarding molecules containing the removed unstable hydroxyl groups created during the conversion of the alcohol molecules into the alkene molecules;
extracting a hydrogen gas by separating hydrogen atoms from the alkene molecules;
measuring an isotopic composition, i.e., isotopic relative ratio of hydrogen and deuterium in the hydrogen gas; and
comparing the measured isotopic composition with an isotopic composition of alcohols having known origins.
